(19) United States
(12) Patent Application Publication
(10) Pub. No.: US 2006/0103258 A1
(43) Pub. Date: May 18, 2006

(54) Rotating electric machine, and winding method and core therefor

(76) Inventors: Yoshiki Nakano, Hamamatsu-shi (JP); Yasuhide Ito, Hamamatsu-shi (JP)

Correspondence Address: Marsh Fischmann & Breyfogle LLP, Suite 411, 3151 South Vaughn Way, Aurora, CO, 80014, US

(21) Appl. No.: 11/271,170

(22) Filed: Nov. 10, 2005

(30) Foreign Application Priority Data
Nov. 16, 2004 (JP) 2004-331736

(51) Int. Cl. H02K 1/00; H02K 1/28; H02K 1/12

(52) U.S. Cl. 310/218; 310/259; 29/598; 310/216

(57) ABSTRACT

A method for winding a wire in a rotating electric machine provided with an armature including a plurality of core members. Each core member has two teeth arranged at an interval of 180 degrees. A connecting portion and an annular portion connect the two teeth. The core members are joined together so that the teeth extend radially. The wire is wound around each tooth of the armature. The method includes separating a tooth from an adjacent tooth when the core members are joined together, and winding a wire around the separated tooth.

### BACKGROUND OF THE INVENTION

The present invention relates to a winding method for a rotating electric machine, a core for a rotating electric machine, and a rotating electric machine.

In the prior art, an armature of a rotating electric machine, such as a motor, includes a core. Many teeth, around which wires are wound, extend radially from the core. Japanese Laid-Open Patent Publication No. 9-46941 describes an example of such a core. The core described in the publication includes an armature with six teeth. The armature core is formed by joining three core members. Two of the core members function as teeth portions, which are arranged at an angular interval of 180 degrees, and the remaining core member functions as a connecting portion, which connects the two teeth portion. A wire is wound around each tooth of the core members before joining the core members. Then, the three core members are connected to one another in the axial direction. This winding method enables the wire to be easily wound around each tooth with a high space occupying rate without adjacent teeth portions interfering with each other in the circumferential direction when the core members are connected to one another.

With the above winding method for a rotating electric machine, the core members are joined together in the axial direction after wires are wound around the teeth of the core members. Thus, the wires wound around the teeth may be rubbed against one another when the core members are joined together. This may inflict damage on the wires.

Further, a wire is wound around each tooth of the core members before the core members are joined together. Thus, after the winding, the wire must be cut once for at least each core member. As a result, with this winding method, a wire cannot be continuously wound around many teeth. This lowers the winding efficiency as a whole. The winding method further requires the ends of the cut wires to be held when the core members are joined together. This complicates the operation for joining the core members. Further, this winding method requires special equipment, such as a jig, for holding the ends of the wires.

### SUMMARY OF THE INVENTION

It is an object of the present invention to provide a winding method for a rotating electric machine, a core for a rotating electric machine, and a rotating electric machine that enable easy winding of a wire with a high space occupying rate while preventing the wire from being damaged.

A first aspect of the present invention is a method for winding a wire around each tooth of an armature including a plurality of core members. Each core member has two teeth arranged at an interval of 180 degrees and a teeth connecting portion for connecting the two teeth. The core members are joined together so that the teeth extend radially. The method includes the steps of separating a certain one of the teeth from the teeth that are adjacent in a state in which the core members are joined together, and winding a wire around the separated certain one of the teeth after the step of separating.

A second aspect of the present invention is a method for winding a wire around each tooth of an armature including a plurality of core members. Each core member has two opposing teeth arranged at an interval of 180 degrees. The core members are joined together so that the teeth extend radially. The method includes the steps of joining the core members to extend along an axis of the armature, projecting one tooth of a certain one of the core members by radially moving the certain one of the core members in a state in which the core members are joined together, winding the wire around the projecting tooth, and returning the certain one of the core members to its original position after winding the wire around the projecting tooth. The step of projecting, the step of winding, and the step of returning are repeatedly executed for each tooth so that the wire is wound around each tooth.

A third aspect of the present invention is a core for a rotating electric machine including a plurality of core members. Each core member has two teeth arranged at an interval of 180 degrees and a teeth connecting portion connecting the two teeth. The core members are joined together so that the teeth extend radially. The teeth are movable in the radial direction relative to the teeth that are adjacent in a state in which the core members are joined together.

A fourth aspect of the present invention is a rotating electric machine including the core according to the third aspect, a wire wound around the teeth, and a stator in which the core is rotatably mounted.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing the main part of a motor according to a preferred embodiment of the present invention;

FIG. 2 is a plan view showing a core;

FIG. 3 is an exploded perspective view showing the core;

FIG. 4 is a cross-sectional view taken along line 4-4 in FIG. 2;

FIG. 5 is a plan view showing core members;

FIG. 6 is a perspective view showing the core members;

FIG. 7 is a diagram showing the winding of a wire in the rotating electric machine;

FIG. 8 is a diagram showing the winding of a wire for a rotating electric machine according to a further embodiment of the present invention;

FIG. 9 is a diagram showing the winding of a wire for a rotating electric machine according to another embodiment of the present invention; and

FIG. 10 is a diagram showing the winding of a wire for a rotating electric machine according to still another embodiment of the present invention.

### DETAILED DESCRIPTION OF THE PREFERRED EMBODIMENTS

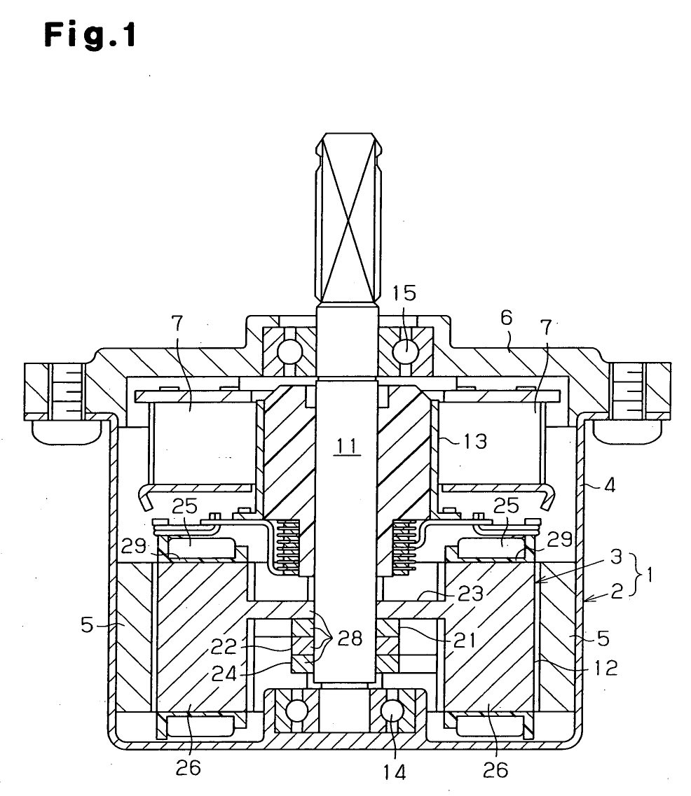

A preferred embodiment of the present invention will now be described with reference to FIGS. 1 to 7. As shown in FIG. 1, a motor 1, which functions as a rotating electric machine, includes a stator 2 and an armature (rotor) 3. The stator 2 includes a yoke housing 4 and a plurality of (six in the preferred embodiment) permanent magnets 5. The yoke housing 4 is a cylindrical body having a closed bottom end. The permanent magnets 5 are secured to the inner circumferential surface of the yoke housing 4. An end housing 6 is fixed to the yoke housing 4 to cover the opening of the yoke housing 4. The end housing 6 supports anode and cathode power supply brushes 7.

The armature 3 includes a rotation shaft 11, a core (armature core) 12, and a commutator 13. The core 12 is fixed to the rotation shaft 11. The commutator 13 is fixed to the rotation shaft 11. The two ends of the rotation shaft 11 are rotatably supported by bearings 14 and 15. The bearing 14 is located at a central portion of the bottom of the yoke housing 4. The bearing 15 is located at a central portion of the end housing 6. The core 12 is arranged to face the permanent magnets 5 in a manner surrounded by the permanent magnets 5. The commutator 13 is arranged so that the anode and cathode power supply brushes 7 are directly pressed against the outer circumferential surface of the commutator 13. The rotation shaft 11 has a distal portion projecting out of the end housing 6.

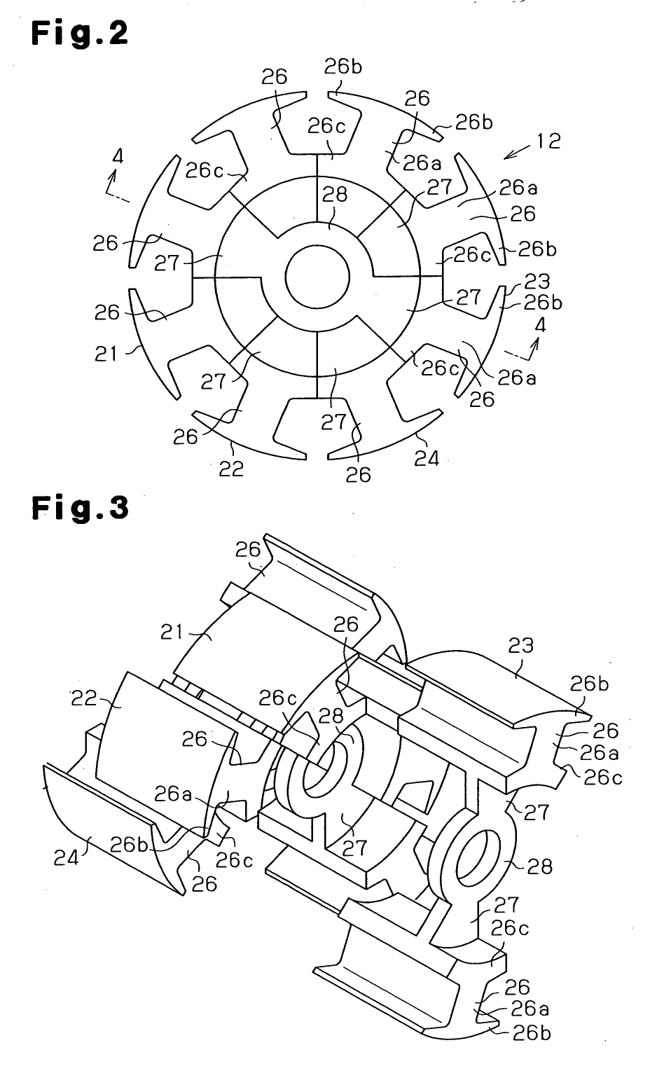

As shown in FIG. 2, the core 12 is formed by joining a plurality of (four in the preferred embodiment) core members 21 to 24 (refer to FIG. 3). Further, the core 12 includes a plurality of (eight in the preferred embodiment) teeth 26, which extend radially. A wire 25 (refer to FIG. 1) is wound around each of the teeth 26.

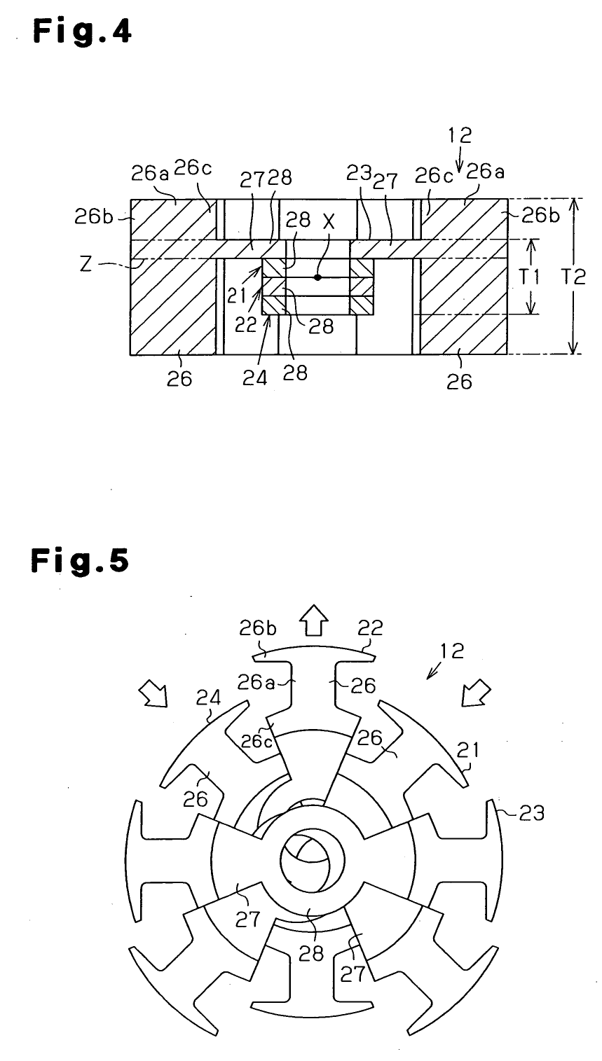

In detail, each of the core members 21 to 24 is formed by laminating sheet materials in the axial direction of the core 12 and fixing the sheet materials by, for example, calking, bonding, or laser welding. The boundary lines between adjacent sheet materials are only shown in part of FIG. 4 (refer to double-dashed lines) and are not shown in the other drawings.

As shown in FIGS. 2 to 4, each of the core members 21 to 24 includes two teeth 26, an annular portion 28, and connecting portions 27. The two teeth 26 are arranged at an angular interval of 180 degrees. The annular portion 28 corresponds to the axis of the core 12. The connecting portions 27 connect the annular portion 28 and the two teeth 26. In the preferred embodiment, the connecting portions 27 and the annular portion 28 define a teeth connecting portion for connecting the two teeth 26. Each connecting portion 27 is generally fan-shaped. The annular portion 28 has circular inner and outer circumferences.

The positions of the connecting portions 27 and the annular portion 28 differ in the axial direction between the core members 21 to 24. In detail, as shown in FIG. 4, the connecting portions 27 and the annular portion 28 of the first core member 21 are formed so that their lower surfaces (as viewed in FIG. 4) are flush with a plane lying along the center X of the teeth 26 in the axial direction. The connecting portions 27 and the annular portion 28 of the second core member 22 are formed so that their upper surfaces (as viewed in FIG. 4) are flush with the plane lying along the center X of the teeth 26 in the axial direction.

The connecting portions 27 and the annular portion 28 of the third core member 23 are formed so that their lower surfaces (lower surfaces in FIG. 4) are spaced upward (upward in FIG. 4) from the plane lying along the center X of the teeth 26 in the axial direction and are flush with the upper surfaces (upper surfaces in FIG. 4) of the connecting portions 27 and the annular portion 28 of the first core member 21. Further, the connecting portions 27 and the annular portion 28 of the third core member 23 are formed so that their upper surfaces (as viewed in FIG. 4) are spaced downward (as viewed in FIG. 4) from the top ends (as viewed in FIG. 4) of the teeth 26 in the axial direction.

The connecting portions 27 and the annular portion 28 of the fourth core member 24 are formed so that their upper surfaces (as viewed in FIG. 4) are spaced downward (as viewed in FIG. 4) from the plane lying along the center X of the teeth in the axial direction and are flush with the lower surfaces (lower surfaces in FIG. 4) of the connecting portions 27 and the annular portion 28 of the second core member 22. Further, the connecting portions 27 and the annular portion 28 of the fourth core member 24 are formed so that their lower surfaces (lower surfaces in FIG. 4) are spaced upward (as viewed in FIG. 4) from the bottom ends (as viewed in FIG. 4) of the teeth 26 in the axial direction.

The first to fourth core members 21 to 24 are joined together by concentrically stacking the annular portions 28 from the bottom, as viewed in FIG. 4, in the order of the fourth core member 24, the second core member 22, the first core member 21, and the third core member 23. Further, the connecting portion 27 and the teeth 26 are shifted from the previous ones by an amount corresponding to one tooth 26, or an angle of 45 degrees (360/8) in the circumferential direction when stacking the fourth core member 24, the second core member 22, the first core member 21, and the third core member 23 (refer to FIG. 3). Thus, when the first to fourth core members 21 to 24 are joined together, the teeth 26 extend radially at regular angular intervals so as to form a spiral stairway with the connecting portions 27. Further, referring to FIG. 4, when the first to fourth core members 21 to 24 are joined together, thickness T1, which is the total thickness of the connecting portions 27 and the annular portions 28 of the first to fourth core members 21 to 24 in the axial direction, is less than thickness T2, which is the thickness of the teeth 26 in the axial direction.

Each tooth 26 includes a pillar portion 26a, a distal portion 26b, and a rotation restriction portion 26c. The pillar portion 26a extends radially. The wire 25 is actually wound around the pillar portion 26a by way of an insulator 29, which is shown in FIG. 1. The distal portion 26b is formed at the radially outward side of the pillar portion 26a. The rotation restriction portion 26c is formed at the radially inward side of the pillar portion 26a. As shown in FIG. 2, the distal portion 26b of each tooth 26 extends in the circumferential direction from the radially outward side of the pillar portion 26a and functions to prevent the wire 25 from falling slipping off the pillar portion 26a in the radially outward direction. As shown in FIG. 2, the rotation restriction portion 26c of each tooth 26 extends in the circumferential direction from the radially inward side of the pillar portion 26a and comes into contact with the rotation restriction portions 26c of the teeth 26 in adjacent core members. Each rotation restriction portion 26c has two end faces formed at an angular interval of 45 degrees.

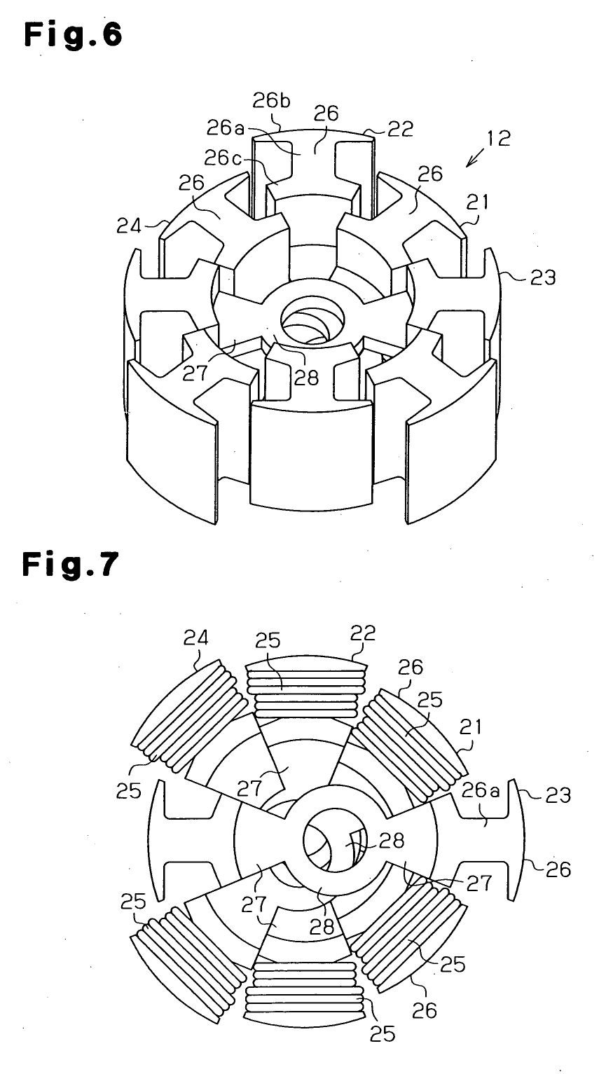

Each tooth 26, that is, the pillar portion 26a, the distal portion 26b, and the rotation restriction portion 26c, has the same thickness T2. Each connecting portion 27 has two end faces that are flush with the end faces of the associated rotation restriction portion 26c and formed at an angular interval of 45 degrees. The core members 21 to 24 of the preferred embodiment are joined so that the teeth 26 are arranged along the same plane when the connecting portions are stacked. In this state, each tooth 26 is movable in the radial direction with respect to the adjacent teeth 26 (refer to FIGS. 5 and 6).

Further, the core members 21 to 24 of the preferred embodiment differ from one another only in axial positions of their connecting portions 27 and annular portions 28. The first and second core members 21 and 22 are identical except in that they are reversed to each other. The third and fourth core members 23 and 24 are also identical except in that they are reversed to each other. In other words, there are two types of core members 21. The core members 21 to 24 are formed by first plates and second plates. The first plates are shaped in correspondence with the cross-sectional shape of only the teeth 26. The second plates are shaped in correspondence with the entire cross-sectional shape of each the core members 21 to 24. That is, each second plate is shaped in correspondence with the teeth 26, the connecting portions 27, and the annular portion 28. In each of the core members 21 to 24, the second plates are stacked to form a plate assembly Z, as shown by the double-dashed lines in FIG. 4, to form the connecting portions 27 and the annular portion 28.

The method for winding the wire 25 around each tooth 26 in the rotating electric machine will now be described. The winding method according to the preferred embodiment includes a radial separation process and a winding process.

The radial separation process will be now described. Referring to FIGS. 5 and 6, in a state in which the core members 21 to 24 are all concentrically joined together. In the radial separation process, the first teeth 26 of the second core member 22 are radially separated from the adjacent first teeth 26 of the first and fourth core members 21 and 24. More specifically, the first teeth 26 of the second core member 22 is pulled outward in the radial direction, and the first teeth 26 of the first and fourth core members 21 and 24 are pressed inward in the radial direction.

In the winding process, the wire 25 is wound, by way of the insulator 29, in a concentrated manner around the pillar portion 26a of the tooth 26 separated in the radial separation process.

Referring to FIG. 7, the wire 25 is wound around each tooth 26 by repeating the radial separation process and the winding process. FIG. 7 shows a manufacturing stage in which the radial separation process and the winding process are being repeated. More specifically, FIG. 7 shows a stage immediately before the wire 25 is wound around the first tooth 26 of the third core member 23. FIG. 7 does not show the insulator 29 and shows the wire 25 schematically.

Subsequently, the core members 21 to 24 are coaxially arranged so that their teeth 26 are located at corresponding positions in the radial direction. In this state, the rotation shaft 11 is press-fitted into the center holes in the annular portions 28 of the core members 21 to 24 (refer to FIG. 1).

In the preferred embodiment, the ends of the wire 25 for each tooth 26 are engaged with and connected to segments of the commutator 13.

This completes the manufacture of the armature 3.

The preferred embodiment has the advantages described below.

(1) The first to fourth core members 21 to 24 are joined in a manner such that their teeth 26 are arranged to lie along the same plane. In this state, each tooth 26 is radially movable relative to the adjacent teeth 26 in the circumferential direction.

In the radial separation process, in a state in which all the core members 21 to 24 are joined together, a tooth 26, for example, the first tooth 26 of the second core member 22, is radially separated from the adjacent teeth 26, for example, the first teeth 26 of the first and fourth core members 21 and 24 that are adjacent in the circumferential direction. In the winding process, the wire 25 is wound around the tooth 26 separated from the other teeth 26 in the radial separation process. Thus, the adjacent teeth 26 do not interfere with the winding, and the wire 25 is easily wound around each tooth 26 with a high space occupying rate. In addition, the wires 25 are wound in a state in which each of the core members 21 to 24 is radially separated. Thus, the core members 21 to 24 are not joined with each other subsequent to the winding of the wire 25 around each tooth 26. This prevents the wires 25 wound around the teeth 26 from rubbing against one another and thus reduces damage to the wires 25. Further, the teeth 26 are all arranged to lie along the same plane when the wire 25 is wound around each tooth 26. Thus, for example, the wire 25 may continuously be wound around a plurality of the teeth 26 without cutting the wire 25. Accordingly, the wire 25 is wound more easily compared to the prior art in which wires are wound around each core member before joining the core members with one another while holding the ends of the wires. Further, special equipment, such as a jig, for holding the ends of the wires 25, is not required as in the prior art.

It should be apparent to those skilled in the art that the present invention may be embodied in many other specific forms without departing from the spirit or scope of the invention. Particularly, it should be understood that the present invention may be embodied in the following forms.

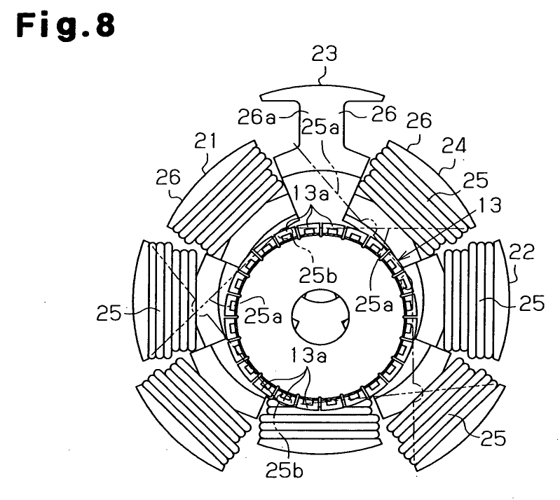

In the preferred embodiment, the ends of the wires 25 that have been wound around the teeth 26 are connected to a segment of the commutator 13 after the radial separation process and the winding process are completed. However, the present invention is not limited in such a manner. The winding method may be modified as shown in FIG. 8.

In detail, FIG. 8 shows a method including a commutator arranging process performed before the winding process. In the commutator arranging process, one commutator 13 is arranged to extend in the axial direction of the core members 21 to 24. Further, the winding process includes a wire engaging process for connecting the wire 25 to a segment 13a of the commutator 13 when the wire 25 is being continuously wound around different teeth 26. In FIG. 8, traversing portions 25a and wire connection portions 25b are indicated using double-dashed lines. The traversing portion 25a extends from one tooth 26 to another tooth 26. Each wire connection portion 25b is engaged with and connected to a segment 13a in the middle of the associated traversing portion 25a. FIG. 8 does not show traversing portions 25a and wire connection portions 25b of wires 25 wound around certain teeth 26.

In this example, after the winding process, the teeth 26 of the core members 21 to 24 are coaxially arranged so that their teeth 26 are located at corresponding positions in the radial direction. Then, the rotation shaft 11 is press-fitted into the center holes of the annular portions 28 in the core members 21 to 24 and the center hole in the commutator 13.

In such a winding method, during the commutator arranging process performed before the winding process, the commutator 13 is arranged to extend in the axial direction of the first to fourth core members 21 to 24. In the wire engaging process included in the winding process, the wire 25 is continuously wound around different teeth 26, and the wire connection portions 25b of the wire 25 are connected to the segments 13a of the commutator 13 during the winding of the wire 25. In other words, the wire 25 is sequentially wound around the plurality of teeth 26 as it is connected to the segments 13a of the commutator 13.

With this winding method, the wire 25 does not need to be cut and may be wound as it is connected to the segments 13a in the same manner as when a wire is wound around the teeth of an integral core that does not include the first to fourth core members 21 to 24. This method does not require the ends of many wires to be temporarily held and simplifies the manufacturing process.

In the separation process of the above embodiment, in a state in which the core members 21 to 24 are all joined together in the axial direction, a tooth 26 is radially separated from the teeth 26 that are adjacent in the circumferential direction. Alternatively, in a state in which at least two core members are joined together, a tooth may be separated from the adjacent teeth in the circumferential direction.

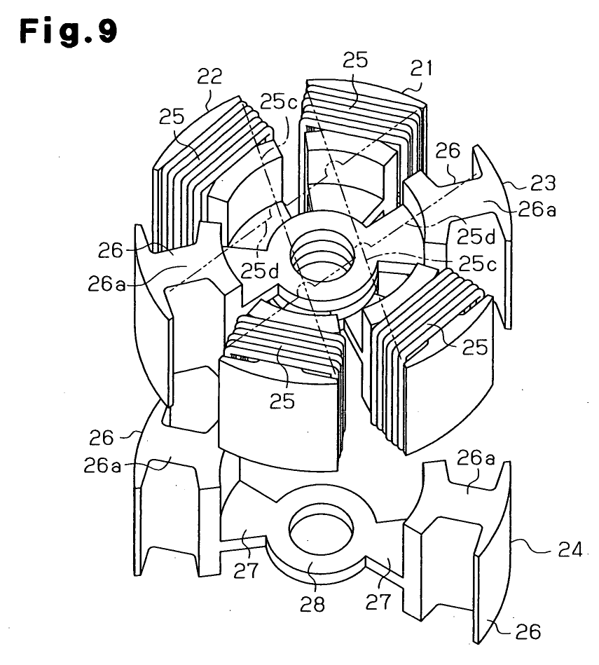

For example, in the separation process, one core member is excluded (the fourth core member 24) when joining the first to third core members 21 to 23. In this state, a tooth 26 may be separated from the adjacent teeth 26 in the circumferential direction, as shown in the state of FIG. 9. In this case, the wires 25 may be simultaneously wound around two teeth 26 arranged at an angular interval of 180 degrees during the winding process, which is performed after the circumferential direction separation process.

In detail, in the circumferential direction separation process, the first to third core members 21 to 23 are joined together. In this state, the six teeth 26 of the first to third core members 21 to 23 are arranged at a regular angular interval (60 degrees). This separates the teeth 26 from one another in the circumferential direction.

Next, in the simultaneous winding process, wires 25 are first simultaneously wound around the two teeth 26 of the second core member 22 that are arranged at an angular interval of 180 degrees. Then, the wires 25 are extended to define traversing portions 25c and continuously wound around the two teeth 26 of the first core member 21 that are arranged at an angular interval of 180 degrees, as shown in FIG. 9. Further, the wires 25 are extended to define traversing portions 25d and continuously wound around the two teeth 26 of the third core member 23 that are arranged at an angular interval of 180 degrees shown in FIG. 9. FIG. 9 shows a stage immediately before the wire 25 is wound around the teeth 26 of the third core member 23.

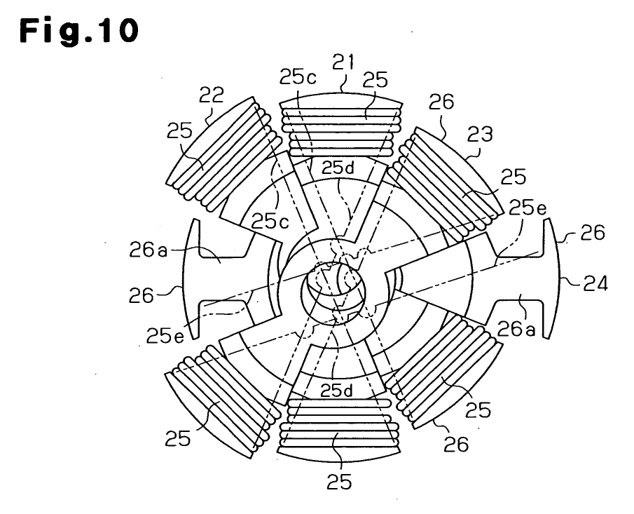

In the radial separation process performed after the winding process, the fourth core member 24 is joined with the first to third core members 21 to 23. In this state, the first tooth 26 of the fourth core member 24 is radially separated from the adjacent teeth 26 (refer to FIG. 10). When joining the fourth core member 24, the first to third core members 21 to 23 are moved relative to one another in the circumferential direction so as to arrange the eight teeth 26 of the core members 21 to 24 at a regular angular interval (45 degrees). In this example, in a subsequent latter winding process, the wire 25 is wound around the first tooth 26 of the fourth core member 24 that has been radially separated. Next, the radial separation process and a latter winding process are sequentially performed to wind the wire 25 around the second tooth 26 of the fourth core member 24. This completes winding of the wire 25 around each tooth 26 of the fourth core member 24. In this example, the wires 25 are wound to the teeth 26 of the fourth core member 24 by performing the latter radial separation process, which is identical to the radial separation process of the preferred embodiment, and the latter winding process, which is identical to the winding process of the preferred embodiment. Further, in this example, after the wires 25 are wound around the teeth 26 of the third core member 23, the wires 25 are extended to define traversing portions 25e (as shown in FIG. 10) and wound around the teeth 26 of the fourth core member 24. The traversing portions 25c, 25d, and 25e are arranged to extend at a side opposite to the side to which the fourth core member 24 is joined (lower side, as viewed in FIG. 9).

With this method, the first to third core members 21 to 23, from which one core member is excluded (the fourth core member 24 in this example), are joined together in the circumferential-direction separation process. In this state, each tooth 26 is separated from the adjacent teeth 26 in the circumferential direction. In the winding process, the wires 25 are wound around the teeth 26 of the first to third core members 21 to 23 that are separated from one another in the circumferential direction. This easily winds the wires 25 around each tooth 26 with a high space occupying rate without interference from the adjacent teeth 26. Further, in the simultaneous winding process, the wires 25 are simultaneously wound around two teeth 26 that are arranged at an angular interval of 180 degrees in each of the first to third core members 21 to 23. This shortens the winding time required for the first to third core members 21 to 23 in comparison with the preferred embodiment. As a result, the entire winding time is shortened.

In the latter radial separation process that is performed after the simultaneous winding process, the fourth core member 24 is joined with the first to third core members 21 to 23. The teeth 26 of the fourth core member 24 are radially separated from the teeth 26 that are adjacent in the circumferential direction. In the latter winding process, the wires 25 are wound around the teeth 26 separated in the latter radial separation process. This easily winds the wires 25 around each tooth 26 of the fourth core member 24 with a high space occupying rate without interference from the adjacent teeth 26. Further, the core members 21 to 24 are not joined together in the axial direction in a state in which the wires 25 are wound around their teeth 26. Thus, the wires 25 are not rubbed against in the axial direction when joining the core members 21 to 24. This example (FIGS. 9 and 10) may, of course, be modified to include the commutator arranging process and the wire engaging process described above.

In the preferred embodiment, the connecting portions 27 and the annular portion 28 define the teeth connecting portion. However, the structure of the teeth connecting portion (shapes of the connecting portions 27 and the annular portion 28) may be changed as long as the teeth connecting portion connects the two teeth 26 arranged at an angular interval of 180 degrees.

In the preferred embodiment, each of the core members 21 to 24 is formed by laminating and fixing sheet materials in the axial direction. However, the structure of each of the core members 21 to 24 is not limited in such a manner. For example, each of the core members 21 to 24 may be formed by compression-molding magnetic powder.

In the preferred embodiment, the present invention is embodied as an 8-slot 6-pole motor (six permanent magnets 5 and eight teeth 26). However, the prevent invention is not limited in such a manner and may be embodied other rotating electric machines, including motors and generators, having a different number of poles and slots.

The present examples and embodiments are to be considered as illustrative and not restrictive, and the invention is not to be limited to the details given herein, but may be modified within the scope and equivalence of the appended claims.

1. A method for winding a wire around each tooth of an armature including a plurality of core members, each core member having two teeth arranged at an interval of 180 degrees and a teeth connecting portion for connecting the two teeth, wherein the core members are joined together so that the teeth extend radially, the method comprising the steps of:
separating a certain one of the teeth from the teeth that are adjacent in a state in which the core members are joined together; and
winding a wire around the separated certain one of the teeth after the step of separating.

2. The method according to claim 1, wherein the step of separating includes separating the certain one of the teeth radially from the teeth that are adjacent.

3. The method according to claim 1, wherein:
the step of separating includes excluding at least one of the core members of the armature, joining the remaining core members, and separating the teeth of the joined core members in a circumferential direction of the armature from the teeth that are adjacent; and
the step of winding includes simultaneously winding the wire around the two teeth of each of the joined core members.

4. The winding method according to claim 3, further comprising the steps of:
after the step of winding, joining the at least one core member with the joined core members, and separating the teeth of the at least one core member radially from the teeth that are adjacent; and
winding the wire around the teeth of the at least one core member that has been separated.

5. The winding method according to claim 1, further comprising the step of:
arranging a commutator on the core members to extend in an axial direction of the armature before the step of winding;
wherein the step of winding includes engaging the wire to a segment of the commutator while the wire is being continuously wound around different teeth.

6. A method for winding a wire around each tooth of an armature including a plurality of core members, each core member having two opposing teeth arranged at an interval of 180 degrees, wherein the core members are joined together so that the teeth extend radially, the method comprising the steps of:
joining the core members to extend along an axis of the armature;
projecting one tooth of a certain one of the core members by radially moving the certain one of the core members in a state in which the core members are joined together;
winding the wire around the projecting tooth; and
returning the certain one of the core members to its original position after winding the wire around the projecting tooth;
wherein the step of projecting, the step of winding, and the step of returning are repeatedly executed for each tooth so that the wire is wound around each tooth.

7. The method according to claim 6, wherein the step of projecting includes moving a core member having a tooth that is adjacent to the one tooth of the certain one of the core members in a direction opposite to the direction in which the certain one of the core members is moved so as to separate the teeth.

8. A core for a rotating electric machine comprising:
a plurality of core members, each core member having two teeth arranged at an interval of 180 degrees and a teeth connecting portion connecting the two teeth, wherein the core members are joined together so that the teeth extend radially, and the teeth are movable in the radial direction relative to the teeth that are adjacent in a state in which the core members are joined together.

9. A rotating electric machine, comprising:
the core for a rotating electric machine according to claim 8;
a wire wound around the teeth; and
a stator in which the core is rotatably mounted.
